(19) United States
(12) Patent Application Publication
(10) Pub. No.: US 2015/0024762 A1
(43) Pub. Date: Jan. 22, 2015

(54) BASE STATION CONTROL DEVICE, METHOD FOR CONTROLLING BASE STATIONS, AND COMPUTER-READABLE RECORDING MEDIUM

(71) Applicant: Samsung Electronics Co., Ltd., Gyeonggi-do (KR)

(72) Inventor: Sung-Rae CHO, Gyeonggi-do (KR)

(73) Assignee: Samsung Electronics Co., Ltd., Gyeonggi-do (KR)

(21) Appl. No.: 14/289,252

(22) Filed: May 28, 2014

(30) Foreign Application Priority Data
Jul. 17, 2013 (KR) 10-2013-0084362

(51) Int. Cl. H04W 24/02; H04W 88/18

(52) U.S. Cl. CPC H04W 24/02; H04W 88/18
USPC 455/450

(57) ABSTRACT

A BS control device and method of controlling BSs by a BS control device are provided. The BS control device includes a wireless communication processor configured to receive, from a BS, identification information indicating a neighboring BS of the BS that satisfies a condition, and a controller configured to allocate arbitrary values to a plurality of BSs controlled by the BS control device, to determine whether to activate a service of the BS by comparing the arbitrary values allocated to each of the plurality of BSs with an arbitrary value allocated to the neighboring BS of the BS, and to control the service of the BS according to a result of determinating whether to activate the service.

### PRIORITY

This application claims priority under 35 U.S.C. §119(a) to Korean Patent Application Serial No. 10-2013-0084362, which was filed in the Korean Intellectual Property Office on Jul. 17, 2013, the entire disclosure of which is hereby incorporated by reference.

### BACKGROUND OF THE INVENTION

1. Field of the Invention

The present invention relates generally to a Base Station (BS) and a BS control device, and more particularly, to a BS control device, a method for controlling BSs by the BS control device, and a computer-readable recording medium.

2. Description of the Related Art

To improve an average data rate of a User Equipment (UE) in a next-generation mobile communication network, an inter-cell frequency reuse scheme, a frequency resource allocation scheme considering intelligent relay communication and user traffic distribution to solve user signal attenuation in a cell boundary region, and a multi-cell joint transmission scheme have been used.

Recently, to provide a wireless environment in which a high-capacity data transmission service may be provided to multiple users, research has been actively conducted on techniques for securing a cell radius by installing an additional BS in a network.

However, if an additional BS is installed indiscriminately to provide a high-capacity data transmission service to multiple users in a particular region, unnecessary interference between existing BSs and the additionally installed BS is often caused, resulting in performance degradation of each of the BSs. To remove unnecessary interference between the BSs, the transmission power of each BS has been controlled. However, controlling the transmission power of each BS fails to consider an interference signal corresponding to a separation distance between the BSs located randomly in an actual network structure and a variation in the distribution of UEs using the respective BSs.

### SUMMARY OF THE INVENTION

Accordingly, the present invention has been made to at least partially solve, alleviate, or remove at least one of the above-described problems and/or disadvantages and to provide at least one of the advantages described below.

Accordingly, various aspects of the present invention provide a BS control device, a method for controlling BSs by the BS control device, and a computer-readable recording medium, in which activation or deactivation of each BS is determined for each frequency band of the BS, based on an interference strength between BSs.

Various aspects of the present invention also provide a BS control device, a method for controlling BSs by the BS control device, and a computer-readable recording medium, in which information indicating a neighboring BS having an interference strength with respect to a BS that satisfies a threshold condition is transmitted to the BS control device and a BS control message is received from the BS control device to activate or deactivate a service.

In accordance with an aspect of the present invention, a method is provided for controlling BSs by a BS control device. The method includes receiving, from a BS, identification information indicating a neighboring BS of the BS that satisfies a condition, allocating arbitrary values to a plurality of BSs controlled by the BS control device, determining whether to activate a service of the BS by comparing the arbitrary value allocated to each of the plurality of BSs with an arbitrary value allocated to the neighboring BS of the BS, and controlling the service of the BS according to a result of the determining.

In accordance with another aspect of the present invention, a computer-readable recording medium is provided having recorded thereon a program for executing a method of controlling BSs by a BS control device on a computer. The method includes receiving, from a BS, identification information indicating a neighboring BS of the BS that satisfies a condition, allocating arbitrary values to a plurality of BSs controlled by the BS control device, determining whether to activate a service of the BS by comparing the arbitrary value allocated to each of the plurality of BSs with an arbitrary value allocated to the neighboring BS of the BS, and controlling the service of the BS according to a result of the determining.

In accordance with another aspect of the present invention, a BS control device is provided, which includes a wireless communication processor configured to receive, from a BS, identification information indicating a neighboring BS of the BS that satisfies a condition, and a controller configured to allocate arbitrary values to a plurality of BSs controlled by the BS control device, to determine whether to activate a service of the BS by comparing the arbitrary values allocated to each of the plurality of BSs with an arbitrary value allocated to the neighboring BS of the BS, and to control the service of the BS according to a result of the determination.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 illustrates a BS that uses an interference signal strength threshold according to an embodiment of the present invention;

FIG. 2 illustrates a BS that uses a separation distance threshold according to an embodiment of the present invention;

FIG. 3 illustrates a BS control device according to an embodiment of the present invention;

FIG. 4 illustrates signal flow between a BS and a BS control device according to an embodiment of the present invention;

FIG. 5 is a flowchart illustrating a control method for a BS using an interference signal strength threshold according to an embodiment of the present invention;

FIG. 6 is a flowchart illustrating a control method for a BS using a separation distance threshold according to an embodiment of the present invention;

FIG. 7 is a flowchart illustrating a frequency service control method for a BS according to an embodiment of the present invention;

FIG. 8 is a flowchart illustrating a control method for a BS control device according to an embodiment of the present invention;

FIG. 9 is a flowchart illustrating a frequency resource allocation method for a BS control device according to an embodiment of the present invention;

FIG. 10 is a flowchart illustrating a threshold generation method for a BS control device according to an embodiment of the present invention;

FIG. 11 illustrates an example of a network before frequency resource allocation according to an embodiment of the present invention;

FIG. 12 illustrates an example of a network after frequency resource allocation according to an embodiment of the present invention; and

FIGS. 13A and 13B illustrate tables for frequency resource allocation by a BS control device according to an embodiment of the present invention.

Throughout the drawings, like reference numerals will be understood to refer to like parts, components, and structures.

### DETAILED DESCRIPTION OF EMBODIMENTS OF THE INVENTION

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

Although ordinal numbers such as “first,” “second,” etc., will be used to describe various components, those components are not limited by the terms. The ordinal terms are used only for distinguishing one component from another component. Further, the term “and/or” used herein includes any and all combinations of one or more of the associated listed items.

The terminology used herein is for the purpose of describing embodiments only and is not intended to be limiting. As used herein, the singular forms are intended to include plural forms as well, unless the context clearly indicates otherwise. It will be further understood that the terms “comprises” and/or “has” when used in present disclosure, specify the presence of a stated feature, number, step, operation, component, element, or a combination thereof and do not preclude the presence or addition of additional features, numbers, steps, operations, components, elements, or combinations thereof.

Various embodiments of the present invention will be described below using a BS, a BS control device, and a method for controlling a separation distance between BSs.

A BS according to various embodiments of the present invention is located in a network and controlled by a BS control device. A cell of the BS may include one of a mega cell, a macro cell, a micro cell, a pico cell, a femto cell, etc. For example, for a femto cell, a BS may include at least one of a Home Node B (HNB) and a Home eNode B (HeNB).

Further, the BS according to various embodiments of the present invention may serve a single frequency band, serve multi-frequency bands, and serve one of the multi-frequency bands in a switching manner.

Additionally, the BS may broadcast system information and a pilot signal to other BSs located in its cell radius. The system information of the BS may include service frequency band information or synchronization (sync) signals. For example, for a femto cell, the system information of the BS may include at least one of a System Information Block 1 (SIB1) and a System Information Block 2 (SIB2).

The pilot signal may be used by the BS to calculate an interference signal strength between the BS and its neighboring BS. For example, if a second BS exists as a neighboring BS in a cell radius of a first BS, the second BS may receive system information and a pilot signal of the first BS. If the first BS exists in a cell radius of the second BS, the first BS may receive system information and a pilot signal of the second BS.

In a network according to various embodiments of the present invention, BSs may have the same cell radius or different cell radiuses. For example, if each of the BSs having different radiuses in the network is located in a cell radius of a neighboring BS, the BS may receive system information and a pilot signal of the neighboring BS.

A BS control device according to various embodiments of the present invention may perform frequency resource allocation for securing a minimum separation distance between BSs of a network for each frequency band. For example, for a femto cell, the BS control device may include at least one of a Home eNode B Gateway (HeNB-GW) and a Home eNode B Management System (HeNB-MS).

A UE connected to a BS according to various embodiments of the present invention may be any electronic device having a wireless communication function, e.g., a smart phone, a cellular phone, a game console, a Television (TV), a display, a vehicle head-up display unit, a notebook computer, a laptop computer, a tablet computer, a Personal Media Player (PMP), a Personal Digital Assistant (PDA), a navigation system, etc. The UE may be implemented as a pocket-size portable communication UE having a wireless communication function and/or may be a flexible UE or a flexible display UE.

Herein, the term “storing unit” may indicate a data storage device such as a Read Only Memory (ROM), a Random Access Memory (RAM), or a memory card like a Secure Digital (SD) card or a memory stick. Further, a storing unit may also include a non-volatile memory, a volatile memory, a Hard Disk Drive (HDD), or a Solid State Drive (SSD).

Herein, “separation distance” may refer to one of a separation distance between a BS and a neighboring BS, which is calculated based on Global Positioning System (GPS) information provided in the BS, a separation distance between a BS and a neighboring BS, which is calculated based on location information of each BS obtained using triangulation among BSs, and a separation distance between a BS and a neighboring BS, which is calculated based on a signal strength of a frequency served by the neighboring BS.

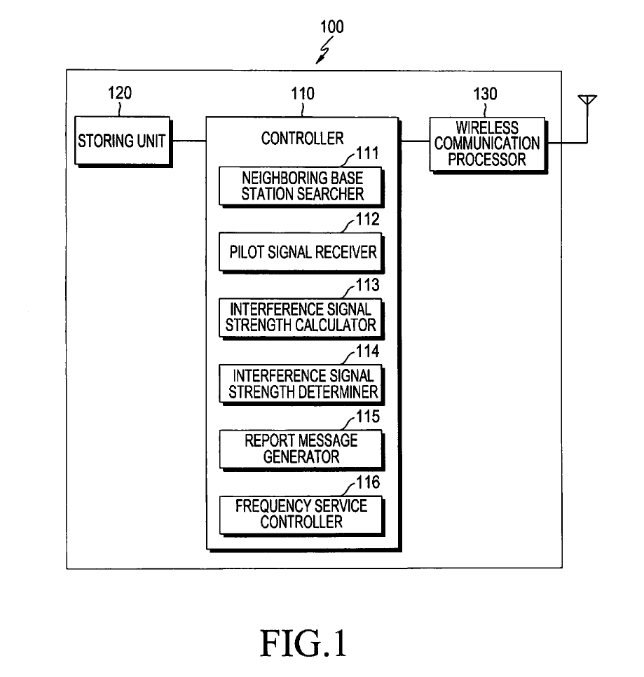

FIG. 1 illustrates a BS that uses an interference signal strength threshold according to an embodiment of the present invention.

Referring to FIG. 1, a BS 100 using an interference signal strength threshold may include a controller 110, a storing unit 120, and a wireless communication processor 130.

The controller 110 controls operations of respective components, and includes a neighboring BS searcher 111, a pilot signal receiver 112, an interference signal strength calculator 113, an interference signal strength determiner 114, a report message generator 115, and a frequency service controller 116.

The neighboring BS searcher 111 searches for system information broadcast from a neighboring BS. As a result of the search, if the system information of the neighboring BS exists, the neighboring BS searcher 111 receives the found system information of the neighboring BS, and stores the received system information of the neighboring BS in the storing unit 120. For example, the system information of the neighboring BS may include service information of each frequency (or frequency-specific service information) of the neighboring BS.

The pilot signal receiver 112 receives a pilot signal of the neighboring BS based on the system information of the neighboring BS. The pilot signal is a pilot signal of a frequency band served by the neighboring BS. Thus, the pilot signal receiver 112 may receive a pilot signal of the same frequency band as a frequency band served by the BS 100. The pilot signal receiver 112 may also receive a pilot signal for each service frequency of the BS 100. For example, the pilot signal receiver 112 may receive a pilot signal broadcast from the neighboring BS based on synchronization (sync) information included in the system information of the neighboring BS. The pilot signal receiver 112 stores the received pilot signal of the neighboring BS in the storing unit 120.

The interference signal strength calculator 113 calculates an interference signal strength between the BS 100 and the neighboring BS based on the pilot signal of the neighboring BS. The interference signal may be generated between BSs that serve the same frequency band. Accordingly, the interference signal strength calculator 113 may calculate an interference signal strength for each frequency of the BS 100 based on pilot signals of the neighboring BS, which correspond to respective frequencies of the BS 100.

The interference signal strength determiner 114 determines whether an interference signal strength for each frequency of the BS 100 is greater than an interference signal strength threshold corresponding to each frequency. If the interference signal strength of the BS 100 is greater than an interference signal strength threshold, the interference signal strength determiner 114 extracts identification information of the neighboring BS having the interference signal strength greater than the threshold from the system information of the neighboring BS.

The interference signal strength determiner 114 may extract the identification information of the neighboring BS from the system information of the neighboring BS received for each frequency of the BS 100. For example, the interference signal strength threshold may be generated for each frequency by the BS control device. Accordingly, the interference signal strength determiner 114 may determine whether the calculated interference signal strength corresponding to a frequency band is greater than the interference signal strength threshold corresponding to the same frequency band, which is received from the BS control device.

The interference signal strength determiner 114 may store, for each frequency, the extracted identification information of the neighboring BS in the storing unit 120. The interference signal strength threshold may be broadcast to each BS from the BS control device through a BS control message.

The report message generator 115 generates the BS report message including the identification information of the neighboring BS, which is extracted for each frequency, and sends the generated BS report message to the BS control device.

The frequency service controller 116 activates or deactivates a service for each frequency of the BS 100 (or a frequency-specific service of the BS 100) according to frequency resource allocation result information. The frequency resource allocation result information may be included in the BS control message and may be broadcast to each BS from the BS control device. For example, the frequency service controller 116 may activate a service of a frequency band which is allocated for serving among frequencies supported by the BS 100. The frequency service controller 116 may also deactivate a service of a frequency band which is not allocated for serving among the frequencies supported by the BS 100.

The storing unit 120 stores a signal or data that is input/output between the components of the BS 100, a signal or data that is input/output between the BS 100 and the BS control device, and a signal or data that is input to/output from the wireless communication processor 130 operating, under control of the controller 110. For example, if the threshold is included in the BS control message received from the BS control device, the controller 110 may store the threshold in the storing unit 120. The BS control message may include at least one of the interference signal strength threshold and the frequency resource allocation result information.

The wireless communication processor 130 receives information of the neighboring BS, or transmits or receives a signal or data to or from the BS control device, under control of the controller 110.

The BS 100, using the interference signal strength threshold according to various embodiments of the present invention described with reference to FIG. 1, may use the interference signal strength threshold generated for each frequency by the BS control device.

The BS 100 determines, for each frequency, whether an interference signal strength associated with a neighboring BS is greater than the interference signal strength threshold. If an interference signal strength for one of the frequencies is greater than the interference signal strength threshold, the BS 100 extracts the identification information of the neighboring BS in the corresponding frequency band from the received system information of the neighboring BS.

The BS 100 generates a BS report message including the extracted identification information of the neighboring BS, and sends the generated BS report message to the BS control device.

The BS 100 receives a BS control message calculated based on the BS report message sent by the BS 100, from the BS control device. The BS 100 activates or deactivates a frequency-specific service of the BS 100 according to the frequency resource allocation result information included in the BS control message. Thus, the BS control device may control the interference signal strength threshold of the BS 100 for each frequency to adjust a rate of BSs activated or deactivated in the network. For example, as the interference signal strength threshold increases, the number of BSs activated may increase, and as the interference signal strength threshold decreases, the number of BSs activated may decrease.

The interference signal strength threshold generated by the BS control device may be generated in consideration of at least one of the number of UEs that use a frequency served in the network, a network Quality of Service (QoS), and an average data rate of a UE.

The interference signal strength threshold for each frequency generated by the BS control device may vary from frequency to frequency.

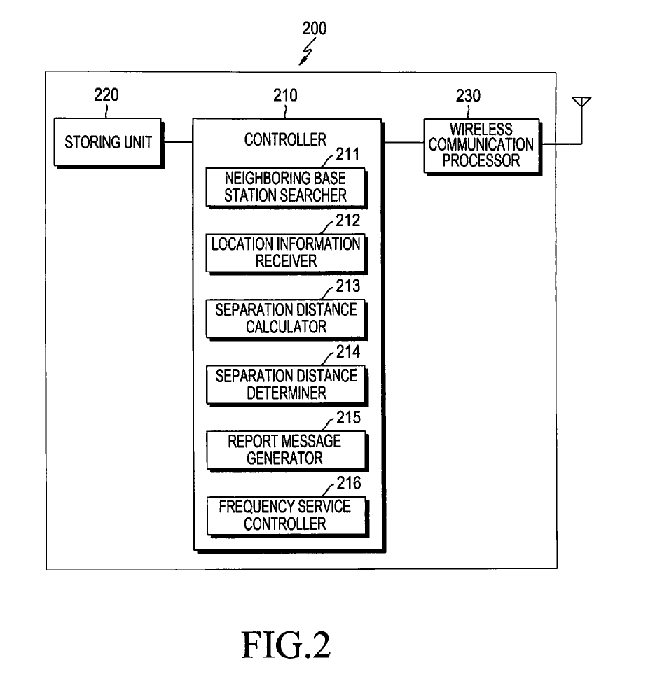

FIG. 2 illustrates a BS that uses a separation distance threshold according to an embodiment of the present invention.

Referring to FIG. 2, a BS 200 that uses the separation distance threshold includes a controller 210, a storing unit 220, and a wireless communication processor 230.

The controller 210 controls operations of respective components of the BS 200. The controller 210 may include a neighboring BS searcher 211, a location information receiver 212, a separation distance calculator 213, a separation distance determiner 214, a report message generator 215, and a frequency service controller 216.

The components of the controller 210 that have the same names as those of the controller 110 of the BS 100 perform similar functions as those of the components described with reference to FIG. 1. Accordingly, a repetitive description of these components is omitted herein.

The neighboring BS searcher 211 searches for the system information broadcast from a neighboring BS, receives the found system information of the neighboring BS, and stores the received system information of the neighboring BS in the storing unit 120.

The location information receiver 212 receives location information from the neighboring BS found by the neighboring BS searcher 211. For example, the location information receiver 212 may extract location information included in the system information of the neighboring BS, may receive location information generated by a Global Positioning System (GPS) included in the neighboring BS, or may receive location information generated through triangulation by the neighboring BS together with other BSs.

The location information receiver 212 may request location information of the neighboring BS from the BS control device and receive the requested location information of the neighboring BS from the BS control device. For example, the location information receiver 212 may extract identification information of the neighboring BS from the system information of the neighboring BS. The location information receiver 212 may request location information of the neighboring BS corresponding to the extracted identification information from the BS control device and then may receive the location information of the neighboring BS from the BS control device.

The separation distance calculator 213 calculates a separation distance between the BS 200 and the neighboring BS based on the location information of the BS 200 and the location information of the neighboring BS received from the location information receiver 212. The separation distance calculated based on the location information of the BS 200 and the location information of the neighboring BS may be uniform for each frequency.

The separation distance calculator 213 may also calculate a separation distance between the BS 200 and the neighboring BS based on a signal strength of a frequency served by the neighboring BS. For example, a separation distance between BSs that use the same frequency may be inversely proportional to an average data rate^{-α} of a UE, in which α indicates a path loss exponent.

When the separation distance calculator 213 calculates the separation distance between the BS 200 and the neighboring BS based on a signal strength of a frequency served by the neighboring BS, the separation distance calculator 213 may perform a calculation for each frequency. For example, if the neighboring BS serves multi-frequency bands, the separation distance calculator 213 may calculate the separation distance based on a signal strength of the same frequency band of the neighboring BS as a frequency band that may be served by the BS 200.

The separation distance determiner 214 may determine whether the separation distance calculated by the separation distance calculator 213 is less than a threshold for a separation distance (or a separation distance threshold) received from the BS control device. If the calculated separation distance is less than the separation distance threshold, the separation distance determiner 214 extracts identification information of the neighboring BS having the separation distance less than the separation distance threshold from the system information of the neighboring BS. The separation distance determiner 214 may also extract, for each frequency of the BS 200, the identification information of the neighboring BS having the separation distance less than the separation distance threshold from the received system information of the neighboring BS.

The separation distance determiner 214 may also extract identification information of a neighboring BS for each frequency of the BS 200. For example, a separation distance threshold may be generated by the BS control device to have different values for different frequencies. Accordingly, the separation distance determiner 214 may determine whether the calculated separation distance corresponding to a frequency band is less than a separation distance threshold corresponding to the same frequency band, which is received from the BS control device.

The separation distance determiner 214 stores the extracted identification information of the neighboring BS in the storing unit 220 for each frequency. The separation distance threshold may be included in the BS control message and may be broadcast to each BS from the BS control device.

The report message generator 215 generates the BS report message including the identification information of the neighboring BS extracted for each frequency and sends the generated BS report message to the BS control device.

The frequency service controller 216 activates or deactivates the frequency-specific service of the BS 200 according to the frequency resource allocation result information. The frequency resource allocation result information may be included in the BS control message and may be broadcast to each BS from the BS control device. For example, the frequency service controller 216 may activate a service of a frequency band which is allocated for serving among frequencies supported by the BS 200. The frequency service controller 216 may also deactivate a service of a frequency band which is not allocated for serving among the frequencies supported by the BS 200.

The storing unit 220 stores a signal or data which is input/output between the components of the BS 200, stores a signal or data which is input/output between the BS 200 and the BS control device under control of the controller 210, and stores a signal or data that is input to/output from the wireless communication processor 230, under control of the controller 210. For example, if the separation distance threshold is included in the BS control message received from the BS control device, the controller 210 may store the separation distance threshold in the storing unit 220. The BS control message may include at least one of the interference signal strength threshold and the frequency resource allocation result information.

The wireless communication processor 230 receives information of the neighboring BS, or transmits or receives a signal or data to or from the BS control device, under control of the controller 210.

The BS 200 may use the separation distance threshold generated for each frequency by the BS control device.

The BS 200 determines, for each frequency, whether a separation distance from a neighboring BS is less than the separation distance threshold. When the separation distance of one of the frequencies is less than the separation distance threshold, the BS 200 extracts the identification information of the neighboring BS in the corresponding frequency band.

The BS 200 generates the BS report message based on the extracted identification information of the neighboring BS and sends the generated BS report message to the BS control device.

The BS 200 receives, from the BS control device, the BS control message calculated based on the BS report message sent from the BS 200. The BS 200 activates or deactivates the frequency-specific service of the BS 200 according to the frequency resource allocation result information included in the BS control message. Accordingly, the BS control device may control the separation distance threshold of the BS 200 for each frequency to adjust a rate of BSs activated or deactivated in the network. For example, as the separation distance threshold increases, the number of activated BSs may decrease, and as the separation distance threshold decreases, the number of activated BSs may increase.

The separation distance threshold generated by the BS control device may be generated in consideration of at least one of the number of UEs that use a frequency served in the network, a network QoS, and an average data rate of a UE.

The separation distance threshold for each frequency generated by the BS control device may vary from frequency to frequency.

While FIGS. 1 and 2 illustrate BSs that receive the interference signal strength threshold or the separation distance threshold from the BS control device, and use that threshold, a BS according to an embodiment of the present invention may also use both of the interference signal strength threshold and the separation distance threshold. The BS control device may control such thresholds in each BS to adjust a rate of BSs activated or deactivated in the network.

For example, when both of the interference signal strength threshold and the separation distance threshold are used, the BS may determine whether a calculated signal strength between the BS and the neighboring BS is greater than the interference signal strength threshold, and may determine whether a calculated separation distance between the BS and the neighboring BS is less than the separation distance threshold. The BS may generate the BS report message including identification information of the neighboring BS that satisfies both of the two conditions, and send the generated BS report message to the BS control device.

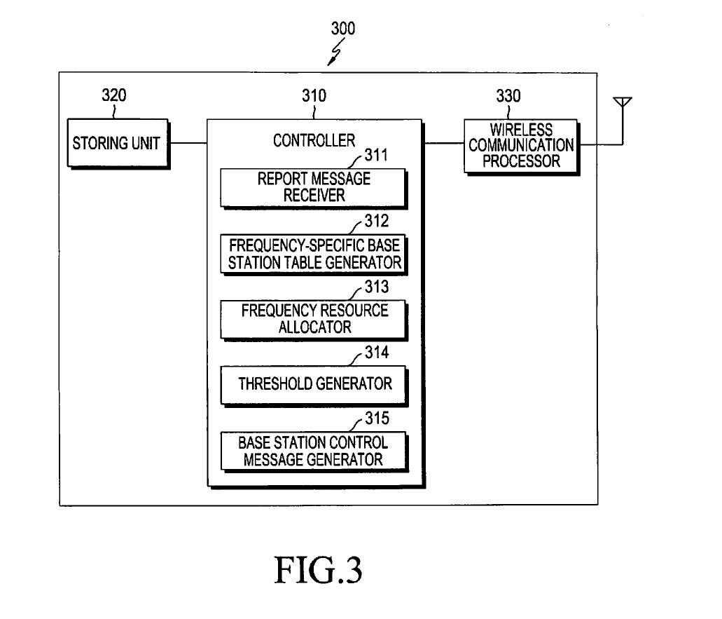

FIG. 3 illustrates a BS control device according to an embodiment of the present invention.

Referring to FIG. 3, the BS control device 300 may include a controller 310, a storing unit 320, and a wireless communication processor 330.

The controller 310 may include a report message receiver 311, a frequency-specific BS table generator 312, a frequency resource allocator 313, a threshold generator 314, and a BS control message generator 315.

The report message receiver 311 may receive BS report messages from BSs of the network through the wireless communication processor 330. The received BS report message may include identification information of a neighboring BS that is determined by comparison with the threshold (or that satisfies the threshold condition) in each BS. For example, the threshold may include at least one of the interference signal strength threshold and the separation distance threshold, which are generated for each frequency by the threshold generator 314.

The frequency-specific BS table generator 312 generates a frequency-specific BS table based on the received BS report messages and identification information of the respective BSs registered in the network.

The frequency-specific BS table may include at least one frequency BS table, which may include identification information of BSs capable of serving a corresponding frequency and identification information of a neighboring BS of each BS. For example, the frequency-specific BS table generator 312 may include information of all the BSs capable of serving a particular frequency to generate a frequency BS table for the frequency.

A frequency BS table for one frequency band may include identification information of each BS in which a service of a corresponding frequency is in an active state, identification information of each BS in which a service of a corresponding frequency is in an inactive state, and identification information of a neighboring BS, which is transmitted from each BS. The identification information of each BS corresponding to the active service and the identification information of the neighboring BS may be included in a BS report message sent from each BS. The identification information of each BS corresponding to the inactive service may be registered and stored in advance in the storing unit 320 of the BS control device 300.

The frequency-specific BS table generator 312 may generate a frequency BS table for one of frequency bands that may be served by each BS. For example, the frequency-specific BS table generator 312 may arrange identification information of each of BSs, which may serve the same frequency band, and identification information of a neighboring BS of each BS, when generating a frequency BS table.

In the frequency BS table, identification information of each BS that sends a BS report message and identification of a neighboring BS of the BS may be arranged together. Further, identification of each BS that does not send a BS report message may also be arranged in the frequency BS table. The frequency BS table generated for each frequency by the frequency-specific BS table generator 312 may be stored in the storing unit 320.

The frequency resource allocator 313 determines activation or deactivation of a frequency service of each BS based on the frequency-specific BS table to generate frequency resource allocation information. More specifically, the frequency resource allocator 313 receives the frequency-specific BS table from the frequency-specific BS table generator 312. To determine activation or deactivation of a frequency service of each of BSs included in one frequency BS table, the frequency resource allocator 313 may allocate contention values, which are different arbitrary values, to the BSs. The frequency resource allocator 313 may perform frequency resource allocation for determining activation or deactivation of a frequency service of each BS through comparison (for example, quantitative comparison) of the contention values allocated to the respective BSs with contention values allocated to neighboring BSs of the BSs. For example, the frequency resource allocator 313 may determine service activation of a BS, if there is no neighboring BS allocated with an arbitrary value having a priority that is higher than that of an arbitrary value allocated to the BS. Service activation of a BS may be activation of a service of a frequency of the BS.

The frequency resource allocator 313 may allocate different arbitrary values to BSs as contention values. For example, the frequency resource allocator 313 may allocate different random values to respective BSs as the arbitrary values. The frequency resource allocator 313 may determine activation or deactivation of a frequency service of each BS according to a priority of a preset random number. That is, the frequency resource allocator 313 compares a priority of a random number allocated to each BS with a priority of a random number allocated to a neighboring BS. If the priority of a BS is higher than that of a neighboring BS, the frequency resource allocator 313 may determine activation of a frequency service of the BS. A priority may be set such that a higher priority is given for a smaller random number or a larger random number.

Once activation or deactivation of a frequency service of each BS is determined, the frequency resource allocator 313 generates frequency resource allocation information for each frequency.

The frequency resource allocator 313 may allocate an arbitrary contention value to each BS in a preset order. That is, the frequency resource allocator 313 may preferentially allocate arbitrary contention values to BSs having high interference with neighboring BSs. For example, an arbitrary value having high priority may be allocated to the BSs having high interference. Each of the BSs may be allocated with an arbitrary value as a contention value. If at least two of the contention values allocated to the respective BSs having high interference have the same value, the frequency resource allocator 313 may determine activation of a frequency service of each of the BSs having the same contention value according to preset settings. The frequency resource allocator 313 may also allocate different random values to the BSs, such that the BSs do not have the same contention value.

The frequency resource allocator 313 performs resource allocation for each frequency, and then generates time slot pattern information for executing a frequency service with respect to BSs having high interference with neighboring BSs through Time Division Multiplexing (TDM). The generated time slot pattern information may be included in the frequency resource allocation information. For example, each BS may share the received time slot pattern information with neighboring BSs.

By using an Almost Black Subframe (ABS) method of enhanced Intercell Interference Cancellation (eICIC), more time slots that are available when a frequency service is provided may be allocated to a BS to which more UEs are connected than neighboring BSs of the BS.

The threshold generator 314 generates a threshold based on at least one of the number of UEs that are using a frequency served in a network, a network QoS, and an average data rate of a UE. For example, the BS control device 300 receives system information of BSs registered in the network and recognizes at least one of the number of UEs that are using a service frequency of each BS, a QoS of a frequency of each BS, and an average data rate of a UE from the received system information. The threshold generator 314 may generate a threshold that may provide a preset network QoS and a preset average data rate of a UE, based on at least one of the received system information. The preset network QoS and the preset average data rate of a UE may be stored in the storing unit 320 for each frequency prior to generation of a threshold.

The threshold generated by the threshold generator 314 may include at least one of an interference signal strength threshold and a separation distance threshold, and may be generated for each frequency, where each threshold may have a different value. For example, the threshold generator 314 may generate at least one of an interference signal strength threshold and a separation value threshold, based on at least one of the number of UEs that are using a current service frequency among UEs registered in the BS control device 300 and an average data rate of a UE. The interference signal strength threshold may be generated using Equation (1).

$$Interference Signal Strength Threshold Value = C \times {( Average Data Rate \times Number of UEs )}^{\frac{α}{2}} \qquad ( 1 )$$

In Equation (1), a represents a path loss exponent for each frequency, the average data rate (bps/Hz/user) represents a data rate to be guaranteed at least for each frequency, the number of UEs represents the number of UEs that are using a service among UEs registered in the BS control device 300, and C represents a constant value that is set for each frequency based on network characteristics such as a power strength of each BS, a network capacity, and channel characteristics. C may be set by testing or experimentation.

The separation distance threshold may be generated using Equation (2).

Separation Distance Threshold Value=C′×(Average Data Rate×Number of UEs)^{-1/2} (2)

In Equation (2), the average data rate (bps/Hz/user) represents a data rate to be guaranteed at least for each frequency, the number of UEs represents the number of UEs that are using a frequency service among UEs registered in the BS control device 300, and C′ represents a constant value that is set for each frequency, based on network characteristics such as a power strength of each BS, a network capacity, and channel characteristics. C′ may be set by testing or experimentation, and may be set to be a value that is different from C.

The separation distance threshold may be generated to at least reflect a minimum separation distance between BSs for each frequency.

The BS control message generator 315 generates a BS control message including at least one of frequency resource allocation information and a threshold. The BS control message generator 315 may receive the frequency resource allocation information generated for each frequency by the frequency resource allocator 313 and/or may receive the threshold generated by the threshold generator 314.

The storing unit 320 stores input/output signals or data under control of the controller 310 and may store input/output signals or data of the wireless communication processor 330 that operates under control of the controller 310.

The wireless communication processor 330 may transmit and receives signals or data to and from each BS under control of the controller 310.

The BS control device 300 may generate a threshold and broadcast the generated threshold to each BS, such that the BS may determine a strength of an interference signal with a neighboring BS. For example, if an interference signal strength with respect to a neighboring BS satisfies a threshold condition, each BS may generate a BS report message including identification information of the neighboring BS that satisfies the threshold condition, and send the BS report message to the BS control device 300. The BS control device 300 may generate a frequency-specific BS table based on the received BS report message of each BS.

The BS control device 300 broadcasts a BS control message including information indicating whether to activate or deactivate a frequency service of each BS to the BS. For example, the BS control device 300 may allocate a random value to each BS included in the frequency-specific BS table. The BS control device 300 determines whether to activate or deactivate a frequency service of each BS according to a priority through comparison between random values of BSs. The BS control device 300 generates wireless resource allocation information in which whether to activate or deactivate a frequency service of each BS is determined for each frequency. The BS control device 300 may generate a BS control message including at least one of wireless resource allocation information and a threshold and broadcast the BS control message to each BS. Accordingly, the BS control device 300 may adjust a rate of BSs activated or deactivated in the network, by controlling at least one of a separation distance threshold and an interference signal strength threshold for each frequency. For example, as a separation distance threshold increases, the number of activated BSs decreases. Similarly, as the separation distance threshold decreases, the number of activated BSs may increase.

Also, as an interference signal strength threshold increases, the number of activated BSs increases. Similarly, as the interference signal strength threshold decreases, the number of activated BSs may decrease.

Components of the controllers of the BSs 100 and 200 and the BS control device 300 have been separately illustrated in the drawings to indicate that they may be functionally and logically separated, but are not intended to mean that they have to be physically separate components or have to be implemented with separate codes.

Herein, each component may represent a functional and structural combination of hardware for executing the technical spirit of the present invention and software for driving the hardware. For example, each component may include a predetermined code and a logical unit of a hardware resource for executing the predetermined code, and it may be easily construed by those of ordinary skill in the art that the component does not necessarily indicate a physically connected code or one type of hardware.

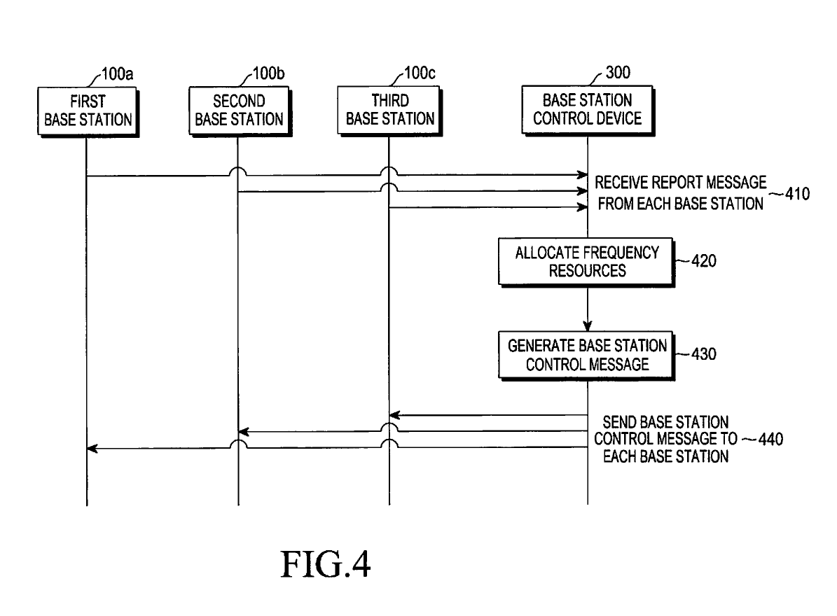

FIG. 4 illustrates signal flow between a BS and a BS control device according to an embodiment of the present invention.

Referring to FIG. 4, a first BS 100a, a second BS 100b, and a third BS 100c are included in the network controlled by a BS control device 300 are shown.

The BS control device 300 receives a BS report message from each BS in step 410. For example, each of the BSs 100a, 100b, and 100c searches for a neighboring BS around itself. Each of the BSs 100a, 100b, and 100c determines whether there is a neighboring BS that satisfies a threshold condition among the found neighboring BSs. If the BS determines that there is a neighboring BS that satisfies the threshold condition, the BS generates a BS report message and sends the BS report message to the BS control device 300.

The BS control device 300 allocates frequency resources to each BS by referring to the received BS report message in step 420. For example, the BS control device 300 may generate a frequency-specific BS table, based on the received BS report message of each BS and information of each BS which is registered in the BS control device 300. The BS control device 300 may perform frequency resource allocation for determining activation or deactivation of a frequency service of each BS, based on the frequency-specific BS table.

The BS control device 300 generates a BS control message including frequency resource allocation information in step 430. The frequency resource allocation information may include information in which whether to activate or deactivate a frequency service of each BS is determined.

The BS control device 300 broadcasts a BS control message to each BS in step 440. Each BS may receive the BS control message from the BS control device 300 and then may activate or deactivate a service for each frequency of the BS according to frequency resource allocation information for each frequency included in the BS control message.

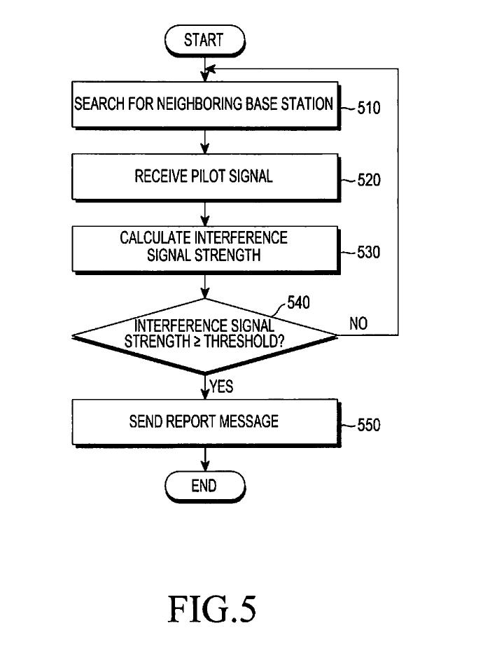

FIG. 5 is a flowchart illustrating a control method for a BS using an interference signal strength threshold according to an embodiment of the present invention.

Referring to FIG. 5, a BS searches for a neighboring BS in step 510. For example, the BS may broadcast its system information in its cell radius. The BS may receive system information of a neighboring BS, which is broadcast from the neighboring BS, to search for the neighboring BS.

The BS receives a pilot signal of the found neighboring BS in step 520. The pilot signal of the neighboring BS received by the BS may be used to calculate an interference signal strength between the BS and the neighboring BS. For example, the BS may receive the pilot signal of the neighboring BS based on the system information of the found neighboring BS. The BS may receive a pilot signal of a frequency of a neighboring BS, which is the same as a frequency that may be served by the BS in pilot signal reception. Thus, the BS may receive the pilot signal of the neighboring BS for each frequency of the BS.

The BS calculates an interference signal strength between the BS and the neighboring BS in step 530. For example, the BS may calculate the interference signal strength between the BS and the neighboring BS that serves the same frequency as the BS, based on the pilot signal of the neighboring BS received for each frequency. Thus, the BS calculates the interference signal strength for each frequency of the BS.

The BS determines whether the calculated interference signal strength for each frequency is greater than an interference signal strength threshold for each frequency in step 540. If the calculated interference signal strength is greater than the interference signal strength threshold, the BS may extract identification information of a neighboring BS having the interference signal whose strength is greater than the interference signal strength threshold from the system information of the neighboring BS. The BS may extract identification of the neighboring BS having the interference signal whose strength is greater than the interference signal strength threshold for each frequency of the BS from the system information of the neighboring BS. If there is no interference signal strength greater than the interference signal strength threshold, the method returns to step 510.

The BS generates a BS report message including the extracted identification information of the neighboring BS and sends the generated BS report message to the BS control device in step 550. The BS report message may include the identification information of the neighboring BS extracted for each frequency of the BS. The identification information of the neighboring BS may include the identification information of the neighboring BS having the interference signal strength greater than the interference signal strength threshold for each frequency of the BS.

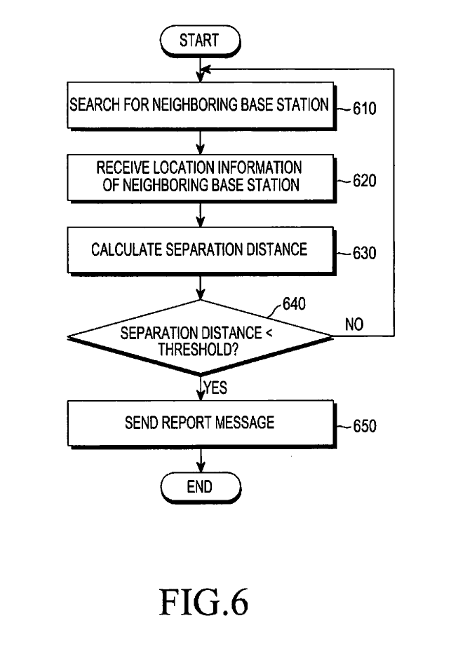

FIG. 6 is a flowchart illustrating a control method for a BS using a separation distance threshold according to an embodiment of the present invention.

Referring to FIG. 6, the BS searches for a neighboring BS in step 610. For example, the BS may broadcast its system information in its cell radius and may receive system information of a neighboring BS, which is broadcast from the neighboring BS, to search for the neighboring BS.

The BS receives location information of the found neighboring BS in step 620. The location information of the neighboring BS received by the BS may be used to calculate a separation distance between the BS and the neighboring BS. For example, the BS may receive the location information of the found neighboring BS based on system information of the neighboring BS. The location information of the neighboring BS may be generated based on information of a GPS provided in each BS.

The location information of the neighboring BS may also be generated by triangulation in the neighboring BS with BSs around the neighboring BS.

The BS may also request location information corresponding to identification of the found neighboring BS from the BS control device, based on the identification of the found neighboring BS. The BS may receive the requested location information of the neighboring BS from the BS control device.

In step 630, the BS calculates a separation distance between the BS and the neighboring BS. For example, the BS may calculate the separation distance between the BS and the neighboring BS that serves the same frequency as the BS, based on the received location information of the neighboring BS.

If there is no received location information of the neighboring BS, the BS may measure a signal strength of a frequency of the found neighboring BS. The BS may calculate an average signal strength of the measured signal strength of the frequency. The BS may calculate the separation distance between the BS and the neighboring BS based on the average signal strength. The separation distance between the BS and the neighboring BS, which is calculated based on the signal strength of the frequency of the neighboring BS, may be calculated for each frequency of the BS.

In step 640, the BS determines whether the calculated separation distance is less than a separation distance threshold for each frequency. If the calculated separation distance is less than the separation distance threshold, the BS extracts identification information of a neighboring BS having the separation distance less than the separation distance threshold from the system information of the neighboring BS. For example, the BS determines whether the separation distance calculated based on the location information received from the neighboring BS is less than the separation distance threshold for each frequency or determines whether the separation distance for each frequency calculated based on a frequency signal strength of the neighboring BS is less than the separation distance threshold for each frequency.

The BS extracts identification information of the neighboring BS having a separation distance less than the separation distance threshold for each frequency of the BS from the system information of the neighboring BS. If there is no separation distance less than the separation distance threshold, the method returns to step 610.

In step 650, the BS generates a BS report message including the extracted identification information of the neighboring BS and sends the generated BS report message to the BS control device. For example, the BS report message may include the identification information of the neighboring BS extracted for each frequency of the BS. The identification information of the neighboring BS may include the identification information of the neighboring BS having the separation distance less than the separation distance threshold for each frequency of the BS.

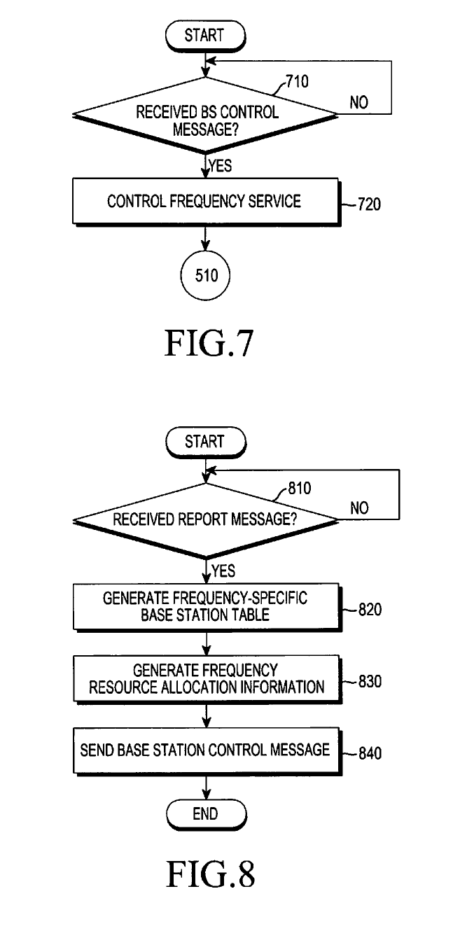

FIG. 7 is a flowchart illustrating a frequency service control method for a BS according to an embodiment of the present invention.

Referring to FIG. 7, when receiving BS control message from the BS control device in step 710, the BS controls a frequency service of the BS according to the BS control message in step 720. For example, the BS control message received by the BS may include frequency resource allocation information in which activation or deactivation of a frequency service of each BS is determined for each frequency by the BS control device. Thus, the BS may activate or deactivate the frequency service of the BS according to the received BS control message.

After frequency service control is performed, the method proceeds to step 510 of FIG. 5. Alternatively, the method may proceed to step 610 of FIG. 6.

FIG. 8 is a flowchart illustrating a control method for a BS control device according to an embodiment of the present invention.

Referring to FIG. 8, the BS control device receives the BS report message from each BS included in the network in step 810. For example, the BS report message received by the BS control device from each BS may include identification information of a neighboring BS for each frequency of the BS. The identification information of the neighboring BS is identification information of a neighboring BS that satisfies a threshold condition in each BS.

In step 820, the BS control device generates a frequency-specific BS table based on the received BS report message. The BS control device may generate a frequency-specific BS table based on BSs registered in the network. For example, the BS control device generates a frequency-specific BS table including information about BSs that send a BS report message to the BS control device and BSs that do not send a BS report message to the BS control device among the BSs registered in the network. Thus, the BS control device generates a frequency-specific BS table including information about BSs that may serve each frequency. The BSs that may serve each frequency may include BSs whose frequency service is activated and BSs whose frequency service is deactivated.

In step 830, the BS control device generates frequency resource allocation information based on the generated frequency-specific BS table. For example, the BS control device may allocate a contention value to each BS included in the frequency-specific BS table. The BS control device may determine whether a contention value allocated to each BS has a higher priority than a contention value allocated to a neighboring BS of the BS. If a priority of the contention value of the BS is higher than a contention value of a neighboring BS of the BS, activation of a frequency service of the BS may be determined.

As another example, if the priority of the contention value of the BS is lower than that of the contention value of the neighboring BS, deactivation of the frequency service of the BS may be determined. The BS control device may generate frequency resource allocation information including information indicating whether to activate or deactivate a frequency service of the BS for each frequency.

In step 840, the BS control device generates the BS control message including the frequency resource allocation information and sends the generated BS control message to each BS. The BS may receive the BS control message and activates or deactivates the frequency-specific service of the BS.

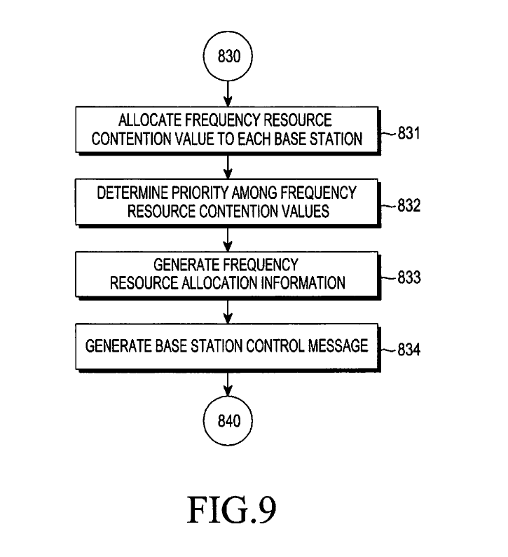

FIG. 9 is a flowchart illustrating a frequency resource allocation method for a BS control device according to an embodiment of the present invention. Specifically, FIG. 9 illustrates step 830 of FIG. 8 in more detail.

Referring to FIG. 9, the BS control device allocates a contention value to each BS based on a frequency-specific BS table in step 831. For example, the BS control device may allocate different random values to respective BSs as contention values.

In step 832, the BS control device determines priorities of contention values allocated to the respective BSs. For example, the BS control device may determine whether a contention value of each BS has a higher priority than that of a neighboring BS of the BS. The BS control device may determine activation of the frequency service to the BS having a higher priority than the neighboring BS.

As another example, the BS control device may determine deactivation of the frequency service of the BS having a lower priority than the neighboring BS.

In step 833, the BS control device generates frequency resource allocation information for each frequency. For example, the frequency resource allocation information for each frequency includes information in which activation or deactivation of the frequency service of each BS is determined.

In step 834, the BS control device generates the BS control message including the frequency resource allocation information for each frequency. After the BS control message is generated, the method proceeds to step 840 of FIG. 8.

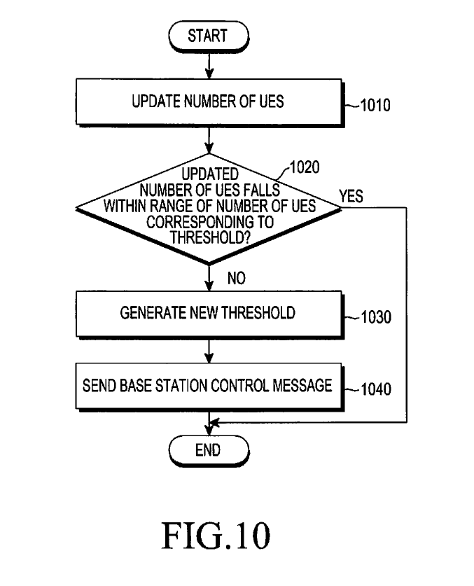

FIG. 10 is a flowchart illustrating a threshold generation method for a BS control device according to an embodiment of the present invention.

Referring to FIG. 10, the BS control device updates the number of UEs that are using a frequency served in the network in step 1010. For example, the network device may receive information about the UEs that are using the frequency served by the BS.

As another example, the BS control device may update a network QoS. The network device may receive information about a QoS of a frequency served by each BS from the BS or each UE of the network.

As another example, the BS control device may update a data rate and the network device may receive information about a data rate of a frequency served by each BS from the BS or each UE of the network.

In step 1020, the BS control device determines whether the updated number of UEs falls within a range of the number of UEs corresponding to a current threshold. If the updated number of UEs is out of the range of the number of UEs corresponding to the threshold, the base station control device generates a new threshold in step 1030. However, if the updated number of UEs falls within the range of the number of UEs corresponding to the threshold, the BS control device terminates threshold generation.

As another example, the BS control device may determine whether the updated network QoS is in a range of a network QoS corresponding to the current threshold. If the updated network QoS is out of the range of the network QoS corresponding to the current threshold, the BS control device generates a new threshold in step 1030. However, if the updated network QoS is in the range of a network QoS corresponding to the current threshold, the bas station control device may terminate threshold generation.

As another example, the BS control device may determine whether the updated data rate is in a range of a data rate corresponding to the current threshold. If the updated data rate is out of the range of the data rate corresponding to the current threshold, the BS control device generates a new threshold in step 1030. However, if the updated data rate is in the range of the data rate corresponding to the current threshold, the BS control device may terminate threshold generation.

In step 1030, the BS control device may generate a threshold based on at least one of the number of UEs that are using a frequency served in the network, a network QoS, and an average data rate of a UE. The threshold may be generated to have a value greater than a preset QoS by the BS control device. For example, the BS control device may generate the threshold to reflect the number of UEs. The BS control device sets a range of the number of UEs, and divides the set range into regions. The BS control device may generate a threshold corresponding to each region obtained by dividing the range.

As another example, the BS control device may generate a threshold to reflect a network QoS. The BS control device sets a range of a network QoS and divides the set range into regions. The BS control device generates a threshold corresponding to each region obtained by dividing the range.

As another example, the BS control device may generate a threshold to reflect a data rate of a network service frequency. The BS control device sets a range of a data rate of a network service frequency and divides the set range into regions. The BS control device generates a threshold corresponding to each region obtained by dividing the range.

In step 1040, the BS control device generates a BS control message including the generated threshold and sends the generated BS control message to each BS. Each bas station may receive the BS control message from the BS control device and may store and update the received threshold.

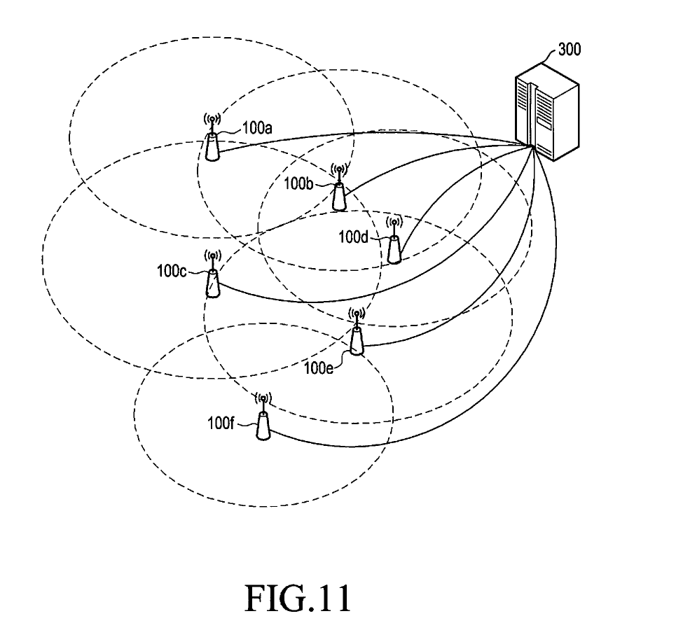

FIG. 11 illustrates an example of a network before frequency resource allocation according to an embodiment of the present invention.

Referring to FIG. 11, a first BS 100a, a second BS 100b, a third BS 100c, a fourth BS 100d, a fifth BS 100e, and a sixth BS 100f are included in the network controlled by the BS control device 300.

An interference signal may be generated between BSs that serve the same 10 frequency. Thus, the quality of the frequency served in the BSs 100a, 100b, 100c, 100d, 100e, and 100f may be degraded by the interference signal.

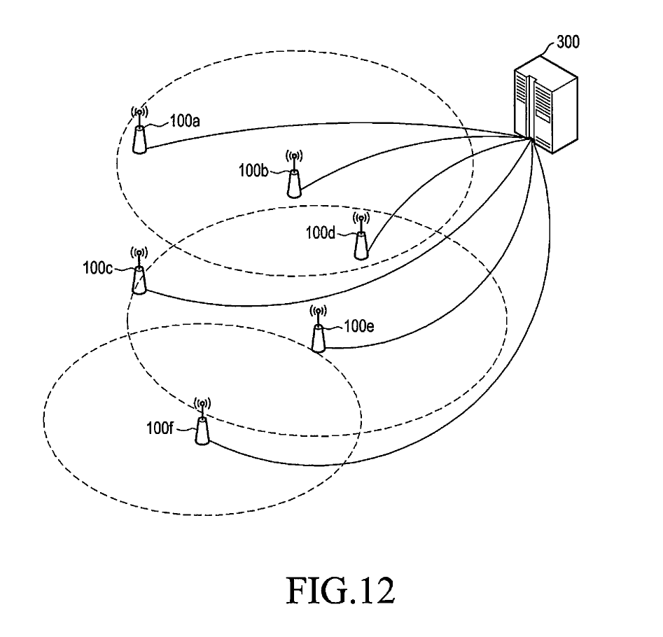

FIG. 12 illustrates an example of a network after frequency resource allocation according to an embodiment of the present invention.

Referring to FIG. 12, the first BS 100a, the second BS 100b, the third BS 100c, the fourth BS 100d, the fifth BS 100e, and the sixth BS 100f are included in the network controlled by the BS control device 300.

In FIG. 12, services of the second BS 100b, the fifth BS 100e, and the sixth BS 100f are activated by the BS control device. Also, services of the first BS 100a, the third BS 100c, and the fourth BS 100d are deactivated by the BS control device 300.

After the BSs 100a, 100b, 100c, 100d, 100e, and 100f identify neighboring BSs that use the same frequencies as the BSs 100a, 100b, 100c, 100d, 100e, and 100f, they may report the identifications to the BS control device 300. The BS control device 300 may determine activation or deactivation of a frequency service of each BS based on information reported from the BSs 100a, 100b, 100c, 100d, 100e, and 100f. The respective BSs 100a, 100b, 100c, 100d, 100e, and 100f may activate or deactivate their frequency services according to activation or deactivation of the frequency services of the BSs 100a, 100b, 100c, 100d, 100e, and 100f, as determined by the BS control device 30. The BS control device adjusts a rate of BSs whose frequency services are activated or deactivated among the BSs 100a, 100b, 100c, 100d, 100e, and 100f included in the network.

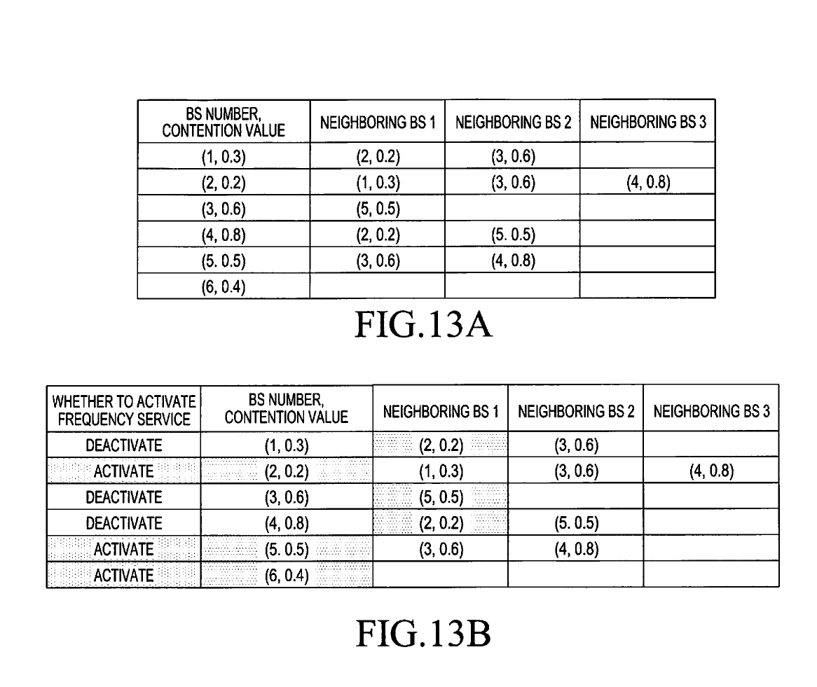

FIGS. 13A and 13B illustrate tables for frequency resource allocation by a BS 10 control device according to an embodiment of the present invention.

FIG. 13A illustrates a frequency-specific BS table generated by the BS control device in which different contention values are allocated to first through sixth BSs having first through sixth BS numbers. The BS control device may receive a BS report message from each BS. The BS report message may include identification information of each BS and identification information of a neighboring BS that serves the same frequency as the BS. The BS control device may allocate different contention values to BS identification numbers. The BS control device may allocate different random values to the BS identification numbers as contention values.

Specifically, the BS control device allocates contention values of 0.3, 0.2, 0.6, 0.8, 0.5, and 0.4 to the first through sixth BSs having the first through sixth BS numbers for one frequency resource. Each BS has a contention relationship with a neighboring BS that uses the same frequency as the BS to be allocated with a frequency resource from the BS control device. For example, for the first BS, the second and third BSs are first and second neighboring BSs that use the same frequency as the first BS. Accordingly, to be allocated with a frequency resource, the first BS has a contention relationship with the second and third BSs, which are neighboring BSs of the first BS. The BS control device compares the contention value of 0.3 allocated to the first BS with the contention values of 0.2 and 0.6 allocated to the first and second neighboring BSs, according to a preset priority order. If there is a neighboring BS allocated with a contention value having a higher priority than a contention value allocated to the first neighboring BS among neighboring BSs of the first BS, the bas station control device determines to deactivate a service of the first BS.

Referring to FIG. 13B, the BS control device determines activation or deactivation of a frequency service of each BS for one frequency resource for frequency resource allocation.

In FIG. 13B, the BS control device determines activation of a service of the second BS having a BS number 2, a service of the fifth BS having a BS number 5, and a service of the sixth BS having a BS number 6. Further, the BS control device determines deactivation of a service of the first BS having a BS number 1, a service of the third BS having a BS number 3, and a service of the fourth BS having a BS number 4. For example, for the first BS having the BS number 1, the second and third BSs are neighboring BSs that use the same frequency as the first BS. The BS control device determines whether the contention value of 0.3 allocated to the first BS has a higher priority than the contention values of 0.2 and 0.6 allocated to the neighboring BSs of the first BS. If a smaller contention value has a higher priority, because the contention value of the second BS is smallest among the first BS and the neighboring BSs thereof, the first BS may not be allocated with a frequency resource. Accordingly, the BS control device determines deactivation of a frequency service of the first BS.

As another example, the sixth BS has no neighboring BS that serves the same frequency as the sixth BS, such that a frequency resource may be allocated to the sixth BS to allow the sixth BS to serve a frequency without contention with a neighboring BS. Thus, the BS control device may determine activation of a frequency service of the sixth BS.

In FIGS. 13A to 13B, the BS control device may allocate different arbitrary contention values to respective BSs for one frequency resource. The BS control device may determine which one of contention values allocated to a BS and at least one neighboring BSs interfering with the BS has the highest priority according to a preset priority order. If the contention value of the BS has a higher priority than those of the contention values of the neighboring BSs, the BS control device allocates the frequency resource to the BS.

However, in a modified example, each BS may perform priority comparison among a contention value allocated to a BS that desires to be allocated with a frequency resource and contention values allocated to neighboring BSs of the BS. Each BS may receive the allocated contention values and priority information of the contention values. Each BS may determine which one of the contention value allocated to the BS and the contention values allocated to the neighboring BSs has a higher priority according to a preset priority order. Each BS may activate or deactivate a service of the frequency according to the determination result.

The BSs and the BS control devices according to the above-described embodiments of the present invention optimize interference between BSs through control of a separation distance between the BSs based on a change in the distribution of UEs using each BS and an interference level between the BSs.

Further, the BSs and the BS control devices according to the above-described embodiments of the present invention efficiently allocate frequency resources to BSs, thus improving the energy use efficiency of the BSs.

In the foregoing description, specific examples of configurations and components are merely provided to assist the overall understanding of the embodiments of the present invention and it will be apparent to those skilled in the art that the present invention is not limited to these examples and various modifications and changes may be possible from the embodiments.

While the present invention has been particularly illustrated and described with reference to certain embodiments thereof, various modifications or changes can be made without departing from the scope of the present invention. Therefore, the scope of the present invention is not limited to the above-described embodiments, and should be defined by the scope of the following claims and any equivalents thereof.

What is claimed is:

1. A method of controlling Base Stations (BSs) by a BS control device, the method comprising:
receiving, from a BS, identification information indicating a neighboring BS of the BS that satisfies a condition;
allocating arbitrary values to a plurality of BSs controlled by the BS control device;
determining whether to activate a service of the BS by comparing the arbitrary value allocated to each of the plurality of BSs with an arbitrary value allocated to the neighboring BS of the BS; and
controlling the service of the BS according to a result of determining whether to activate the service.

2. The method of claim 1, wherein the condition includes an interference signal strength between the BS and the neighboring BS being greater than a threshold.

3. The method of claim 1, wherein the condition includes a separation distance between the BS and the neighboring BS being less than a threshold.

4. The method of claim 3, wherein the threshold is generated based on a number of User Equipments (UEs) that use services of the plurality of BSs.

5. The method of claim 3, wherein the threshold is generated based on a data rate of the plurality of BSs.

6. The method of claim 2, wherein the threshold is generated based on a number of User Equipments (UEs) that use services of the plurality of BSs.

7. The method of claim 2, wherein the threshold is generated based on a data rate of the plurality of BSs.

8. The method of claim 1, wherein allocating the arbitrary values comprises allocating a different arbitrary value to each of the plurality of BSs.

9. The method of claim 1, wherein allocating the arbitrary values comprises preferentially allocating an arbitrary value having a high priority to a BS having a high interference with respect to the neighboring BS over other BSs.

10. The method of claim 1, wherein determining whether to activate the service of the BS comprises:
determining that there is no neighboring BS allocated with an arbitrary value having a higher priority than a priority of the arbitrary value allocated to the BS; and
determining to activate the service of the BS.

11. The method of claim 1, wherein controlling of the service comprises activating or deactivating a service of a frequency band of the BS.

12. A computer-readable recording medium having recorded thereon a program for executing a method of controlling Base Stations (BSs) by a BS control device on a computer, the method comprising:
receiving, from a BS, identification information indicating a neighboring BS of the BS that satisfies a condition;
allocating arbitrary values to a plurality of BSs controlled by the BS control device;
determining whether to activate a service of the BS by comparing the arbitrary value allocated to each of the plurality of BSs with an arbitrary value allocated to the neighboring BS of the BS; and
controlling the service of the BS according to a result of determining whether to activate the service.

13. A Base Station (BS) control device comprising:
a wireless communication processor configured to receive, from a BS, identification information indicating a neighboring BS of the BS that satisfies a condition; and
a controller configured to allocate arbitrary values to a plurality of BSs controlled by the BS control device, to determine whether to activate a service of the BS by comparing the arbitrary values allocated to each of the plurality of BSs with an arbitrary value allocated to the neighboring BS of the BS, and to control the service of the BS according to a result of determinating whether to activate the service.

14. The BS control device of claim 13, wherein the condition comprises an interference signal strength between the BS and the neighboring BS being greater than a threshold.

15. The BS control device of claim 13, wherein the condition comprises a separation distance between the BS and the neighboring BS being less than a preset threshold.

16. The BS control device of claim 13, wherein the controller allocates a different arbitrary value to each of the plurality of BSs.

17. The BS control device of claim 13, wherein the controller preferentially allocates an arbitrary value having a high priority to a BS having a high interference with respect to the neighboring BS over other BSs.

18. The BS control device of claim 13, wherein the controller determines to activate the service of the BS if there is no neighboring BS allocated with an arbitrary value having a higher priority than a priority of the arbitrary value allocated to the BS.

19. The BS control device of claim 13, wherein the controller activates or deactivates a service of a frequency band of the BS.
